(19) United States
(12) Patent Application Publication
(10) Pub. No.: US 2025/0353330 A1
(43) Pub. Date: Nov. 20, 2025

(54) VEHICLE TYRE

(71) Applicant: Continental Reifen Deutschland GmbH, Hannover (DE)

(72) Inventors: Peter Bogenschütz, Wedemark (DE); Ulrich Behr, Hannover (DE)

(73) Assignee: Continental Reifen Deutschland GmbH, Hannover (DE)

(21) Appl. No.: 18/291,984

(22) PCT Filed: Jul. 14, 2022
(86) PCT No.: PCT/DE2022/200157

§ 371 Date: Jan. 17, 2025

(30) Foreign Application Priority Data
Jul. 27, 2021 (DE) 10 2021 208 109.6

(51) Int. Cl. B60C 13/00; B60C 13/02

(52) U.S. Cl. CPC B60C 13/001; B60C 13/02

(57) ABSTRACT

A vehicle tire having two sidewalls, on at least one sidewall, at least one character is formed from a hatching composed of a multiplicity of ribs which run parallel to one another and which run with spacings to one another of at most 0.60 mm, wherein the character(s) is or are embedded into a sidewall portion having a background design which is composed of a smooth base surface and of elevations and/or depressions which run with spacings to one another and without intersecting and which form a hatching-like pattern. In the background design, the base surface occupies two to ten times the area covered by the elevations and/or depressions, wherein at least 50% of the elevations, and/or depressions run with spacings to one another that amount to two to five times the spacing of the ribs to one another.

### CROSS-REFERENCE TO RELATED APPLICATIONS

The present application is a National Stage Application under 35 U.S.C. § 371 of International Patent Application No. PCT/DE2022/200157 filed on Jul. 14, 2022, and claims priority from German Patent Application No. 10 2021 208 109.6 filed on Jul. 27, 2021, the disclosures of which are herein incorporated by reference in their entireties.

### TECHNICAL FIELD

The invention relates to a vehicle tire having two sidewalls, wherein, on at least one sidewall, at least one character, for example a text character, a numeral or a pictorial element, is formed from a hatching composed of a multiplicity of ribs which run parallel to one another and which run with spacings to one another of at most 0.60 mm, wherein the character(s) is or are embedded into a sidewall portion having a background design which is composed of a smooth base surface and of elevations and/or depressions which run with spacings to one another and without intersecting and which form a hatching-like pattern.

### BACKGROUND

A vehicle tire having a sidewall design configured in such a way is known, for example, from U.S. Pat. No. 5,303,758 B. The sidewall design annularly encircles the sidewall and has a first pattern which forms a background design, said first pattern consisting of a multiplicity of elevations which run rectilinearly in a radial direction, which are equally spaced apart from one another, which are triangular in cross section and which, at their base, have a spacing to one another of around 0.30 mm. At at least one point of the first pattern, there is an embedded second pattern which consists, for example, of the text characters of a set of lettering. The second pattern also consists of a multiplicity of rectilinearly running elevations, the spacing of which to one another substantially corresponds to that of the elevations of the first pattern, wherein the elevations of the second pattern run parallel to one another and in particular have a trapezoidal cross section. The elevations of the second pattern run at an angle of 45° to 90° relative to the elevations of the first pattern. The second pattern is only slightly elevated in relation to the first.

EP 1 859 963 B1 has disclosed a vehicle tire having a sidewall that comprises a decorative strip, which is formed at least over an annular segment and which has indicative sectors. An indicative sector is for example a set of lettering consisting of text characters consisting of a multiplicity of closely spaced elevations running parallel to one another, and is situated within a sidewall portion that has a smooth surface. In an alternative embodiment, the sidewall portion is provided with a hatching consisting of closely spaced elevations, and the set of lettering has text characters with a smooth surface.

Characters—sets of lettering, numerals and pictorial designs—which are formed as hatchings, that is to say from a multiplicity of closely spaced elevations or depressions preferably running parallel to one another, and which are surrounded by smooth surfaces, have proven to be particularly clearly visible or legible on sidewalls. Characters which are formed from hatchings and which are recessed in relation to the surrounding smooth outer surface, which forms the background, are particularly clearly visible, and appear particularly dark. The background provided with a smooth outer surface normally covers relatively large sections of the sidewall. A visually flawless form of these smooth outer surfaces often proves difficult to achieve, in particular owing to the scarcely avoidable formation of imprints of ventilation bores or ventilation inserts that were present in the vulcanizing mold, the formation of other defects and of so-called sidewall indentations, which are construction-induced unevennesses on tire sidewalls owing to carcass layer overlaps in the tire.

### SUMMARY

The invention is thus based on the object of providing, on sidewalls of vehicle tires, a design configuration with which the desired high contrast between the one or more characters—text characters, sets of lettering consisting of text characters, numerals or pictorial designs—on the one hand and the background on the other hand is maintained, and optimum concealment of construction-induced unevennesses and other defects on the sidewall is ensured.

Said object is achieved according to the invention in that, in the background design, the base surface occupies two to ten times the area covered by the elevations and/or depressions, wherein at least 50% of the elevations and/or depressions run with spacings to one another that amount to two to five times the spacing of the ribs to one another.

Therefore, in the case of sidewalls designed according to the invention, instead of a smooth background or a background with a conventional hatching consisting of closely spaced elevations, a background design consisting of loosely or substantially loosely arranged elevations and/or depressions, which nevertheless run in the manner of hatching, is provided. This background design draws the viewer's eye away from any unevennesses, defects and sidewall indentations, without impairing the prominent visibility and the contrast provided in relation to the embedded character or the embedded characters.

In one preferred embodiment, in the background design, the base surface occupies up to five times the area covered by the elevations and/or depressions. It is thus possible to form more conspicuous hatching-like patterns in the background design.

In a further preferred embodiment, in the background design, all of the elevations and/or depressions run with spacings to one another that amount to two to five times the spacing of the ribs to one another. Here, at the same time, provision may be made whereby, in the background design, all of the elevations and/or depressions run with equal or substantially equal spacings to one another. The background design can thus be provided with “classic” hatchings or with hatching-like patterns and thus adapted to the design of the character(s).

The contrast between the character(s) and the background design can in particular also be influenced by the profile of the elevations and/more depressions in the background design. In this regard, it is particularly advantageous if, in the background design, the elevations and/or depressions extend in a radial direction or at an angle of up to 45° with respect to the radial direction.

The elevations and/or depressions in the background design may run rectilinearly or in an altogether arcuate, undulating or zigzag shape. Depending on the chosen profile, any unevennesses, defects or the aforementioned sidewall indentations can be particularly advantageously covered.

A particularly advantageous and conspicuous background design can be achieved with an embodiment in which, in the background design, the elevations and/or depressions run partially in a zigzag or undulating shape and partially rectilinearly or substantially rectilinearly, wherein, in the case of mutually adjacent elevations and/or depressions, a progressive decrease of the angles in the portions of the zigzag profile or undulating shape gives rise to a transition to more rectilinearly running, or to rectilinearly running, elevations and/or depressions, wherein these are then followed again by elevations and/or depressions running in a zigzag or undulating shape with increasing angles in the portions of the zigzag profile or undulating shape.

The sidewall portion provided with the background may be followed by further sidewall portions which are free from characters, which have patterns consisting of elevations/depressions running in a zigzag or undulating shape, and in which a variation of the angles of portions of elevations and/or depressions running in a zigzag or undulating shape, and/or a variation of the spacing of elevations and/or depressions to one another, gives rise to a pattern consisting of pattern elements that appear darker and lighter. In these sidewall portions, the elevations and/or depressions may also run in a very closely spaced manner, in particular at least partially with a spacing of ≤0.60 mm.

The elevations are preferably triangular in cross section, have a greatest height in relation to the base surface of 0.15 mm to 0.50 mm, in particular of up to 0.30 mm, and at their base have a width of 0.30 mm to 0.60 mm. The depressions are preferably V-shaped in cross section, have a greatest depth of 0.15 mm to 0.50 mm, in particular of up to 0.30 mm, and at the level of the base surface have a width of 0.30 mm to 0.60 mm. A hatching-like pattern consisting of such elevations and/or depressions is clearly visible without impairing the contrast with respect to the the embedded character(s).

Characters embedded in the background design, each of which characters is a depression with a depth of 0.20 mm to 1.00 mm in the base surface, on the bottom of which depression the ribs are formed, are particularly dark and contrast-rich in relation to the background design. The ribs run preferably rectilinearly or in an altogether arcuate shape and have a height that is smaller by in particular 0.10 mm to 0.20 mm than the depth of the depression. The ribs have at their base a width of 0.30 mm to 0.60 mm. The ribs are also preferably triangular in cross section. The ribs preferably extend at an angle of 30° to 50° relative to the circumferential direction of the sidewall.

### BRIEF DESCRIPTION OF THE DRAWINGS

Further features, advantages and details of the invention will now be described in more detail on the basis of the drawing, which illustrates exemplary embodiments and in which:

FIG. 1 shows a circumferential segment of a sidewall of a vehicle tire in plan view, featuring one embodiment of the invention,

FIG. 2 shows the detail D from FIG. 1 in a greatly enlarged illustration,

FIG. 3 shows a section along the line Ill-Ill in FIG. 2 in a yet further enlarged illustration,

FIG. 4 shows a section along the line IV-IV in FIG. 1,

FIG. 5 shows an alternative design on the basis of a section similar to FIG. 4,

FIG. 6 shows a circumferential segment of a sidewall of a vehicle tire in plan view, featuring a further embodiment of the invention.

### DETAILED DESCRIPTION

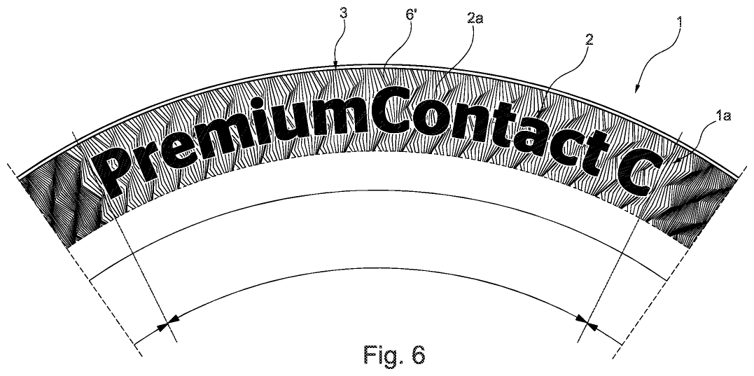

FIG. 1 and FIG. 6 show illustrations, projected onto a plane, of circumferential segments of a sidewall 1 of a vehicle tire having a set of lettering 2 which consists of text characters 2a, said set of lettering being embedded into a sidewall portion 1a which is designed in particular as an annular segment and which has a background design 3. The background design 3 completely surrounds the set of lettering 2 and the text characters 2a thereof, and projects beyond these at all sides by in each case at least 2.00 mm. The sidewall portion 1a may be a constituent part of an overall design that annularly encircles the sidewall 2, wherein a sidewall portion 1a that has a set of lettering 2 is formed in particular at multiple locations over the circumference. The width of the annulus or annular portion as measured in a radial direction ranges from 1.00 cm to 50.00 cm depending on the tire dimensions. Radially within the annulus or annular portion, there are normally situated sidewall regions which are in particular substantially smooth and which are preferably labelled with data that characterize the tire.

In the exemplary embodiments shown, the text characters 2a form the set of lettering “PremiumContact C”. Instead of text characters 2a, it is also possible for other characters, such as numerals, sequences of numerals, pictorial depictions and the like, to be reproduced on the sidewall 2. The description that follows will however refer to text characters, in accordance with the illustrations.

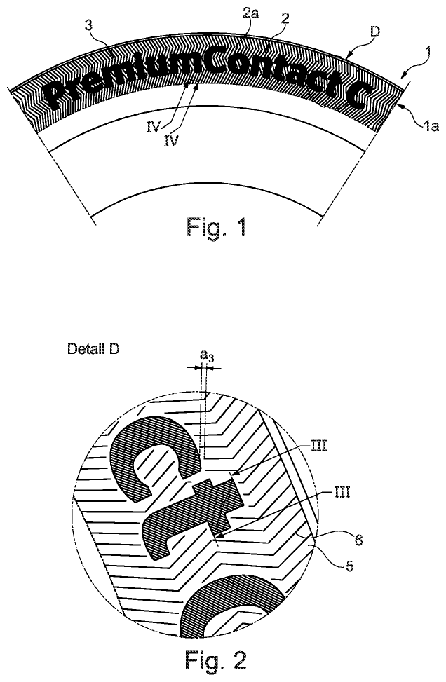

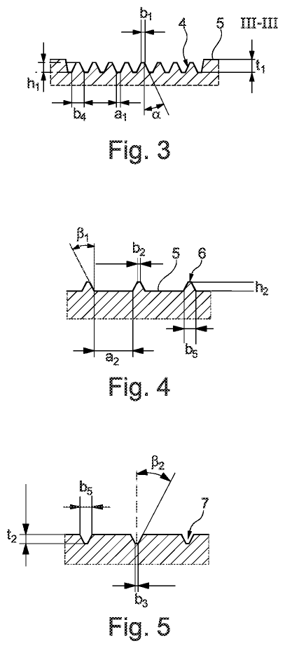

Over the sidewall portion 1a in which the set of lettering 2 is formed or into which the set of lettering 2 is embedded, the background design 3 consists of a base surface 5 which is provided with a smooth surface and in which elevations 6 (FIG. 4) or depressions 7 (FIG. 5) are formed in the manner of hatching, as will be described further below. Aside from the slight concavity of the sidewall 2, the base surface 5 forms a constant, “quasi-planar” base level. The set of lettering 2 is recessed in relation to the base surface 5, that is to say the text characters 2a are formed as depressions of constant depth in the base surface 5 (FIG. 3) and, proceeding from the bottom thereof, are provided with a hatching consisting of a multiplicity of closely spaced or mutually directly adjacent ribs 4 which, as shown in particular in FIG. 2, run rectilinearly and parallel to one another. In alternative embodiments, the ribs 4 run in arcuate or otherwise curved fashion in plan view. Here, the bottom of the depressions is at a depth t₁ of 0.20 mm to 1.00 mm, in particular of 0.40 mm, in relation to the base surface 5. The ribs 4 have a preferably triangular cross section having tip regions with a width b₁ of 0.10 mm to 0.25 mm, having lateral flanks that run at an angle α of 20° to 45° with respect to the base surface 5, and having a height h₁ that is in particular smaller by 0.10 mm to 0.20 mm than the depth t₁. The ribs 4 therefore end below the level of the base surface. At their base, the ribs 4 have no spacing or have an in particular constant spacing a₁, which is equal for all ribs 4, of 0.10 mm to 0.60 mm, in particular of up to 0.30 mm. In an embodiment with a spacing a₁ of 0.10 mm and flank angles of 25°, the mutual spacing of the centers of the tips of adjacent ribs 4 is around 0.50 mm, for example. The ribs 4 have at their base a width b₄ of 0.30 mm to 0.60 mm. In the embodiment shown, the ribs 4 extend at an angle of 30° to 50° relative to the circumferential direction of the sidewall 2.

In the embodiment shown in FIG. 1 and as illustrated in FIG. 4, the background design 3 into which the set of lettering 2 is embedded has a multiplicity of elevations 6 that are formed on the base surface 5. In the embodiment shown, the elevations 6 extend in a radial direction and, owing to the annular shape of the sidewall 1, parallel or virtually parallel to one another, and in the embodiment shown extend in a flat zigzag shape with four rectilinear portions as seen in plan view. The elevations 6 may also extend at any desired angle with respect to the radial direction. This angle is measured on the basis of straight lines that connect the two ends of the elevations 6. The mutual spacing a₂ of the elevations 6 at their base is preferably 1.00 mm to 4.00 mm; in particular, they are triangular in cross section with flank surfaces that have an angle of inclination β₁ relative to the base surface 5 of 20° to 45°. The tip regions of the elevations 6 have a width b₂ of in particular around 0.10 mm to 0.25 mm, and have a height h₂ relative to the base surface 5 of 0.15 mm to 0.50 mm, in particular to 0.30 mm.

FIG. 5 shows an alternative embodiment in which depressions 7 instead of elevations 6 are formed in the base surface 5. The depressions 7 are V-shaped in cross section and therefore have two side flanks which run to the depression base, said side flanks running at an angle β₂ of 20° to 45° relative to the base surface 5. The bottom of the depression has a width b₃ of in particular 0.10 mm to 0.25 mm. The depth t₂ of the depressions 7 is 0.15 mm to 0.50 mm, in particular to 0.30 mm.

The elevations 6 have at their base a width b₅ of in particular 0.30 mm to 0.60 mm; the depressions 7 have this width at the level of the base surface.

FIG. 6 shows an embodiment of the background design 3 having elevations 6′ which are designed analogously to the elevations 6 but which extend in some cases in a zigzag shape and in some cases rectilinearly or virtually rectilinearly in a radial direction over the entire background design 3. In the case of mutually adjacent elevations 6′, a decrease of the angles in the portions of the zigzag profile gives rise to a transition to more rectilinearly running, or to rectilinearly running, elevations 6′, and this is followed by a transition back to elevations 6′ running in a zigzag shape by way of a progressive increase of the angles in the portions of the zigzag. This gives rise to a hatching pattern which is distinguished by a variation of closely spaced elevations 6′ and more widely spaced elevations 6′, whereby pattern elements that appear lighter alternate with pattern elements that appear darker, forming a repeating pattern. As already described, depressions may also be provided instead of elevations 6′.

Both with elevations 6, 6′ and with depressions 7, the background design 3 is provided with a loose hatching-like pattern, wherein the base surface 5 occupies two to ten times the area covered by the elevations 6, 6′ or depressions 7 in relation to the total area of the sidewall portion 1a, and wherein at least 50% of the elevations 6, 6′ or depressions 7 run with spacings to one another that amount to two to five times the spacing of the ribs 4 to one another.

In the embodiments according to FIG. 1 and FIG. 6, elevations 6, 6′ and depressions 7 are interrupted in their profile by the text characters 2a. Here, as can be seen in FIG. 2, the elevations 6, 6′ or the depressions 7 preferably end with a small spacing a₃ (normal spacing to the outer contour of the text character 2a) of 0.10 mm to 0.30 mm to the text characters 2a of the sets of lettering 2.

In an embodiment of an overall design as an encircling annulus, at least one further pattern may be present within the annulus and at locations outside the background design 3 in those sidewall portions which are free from sets of lettering 2, which at least one further pattern is formed by a continuous change or variation of the zigzag shape of the elevations 6, 6′ or of the depressions 7 and of the mutual spacing of the background design 3, such that the individual patterns transition into one another.

As shown in a short segment in FIG. 6, a pattern consisting of pattern elements that appear darker and lighter may be formed by variation of the angles of the zigzag portions of elevations/depressions and a variation of the mutual spacing of the elevations/depressions. In this way, as viewed over the entire circumference of the tire, an overall design can be created in which circumferential portions that appear darker and lighter alternate in a view of the sidewall, wherein sets of lettering 2 that have a deep black appearance are formed in said circumferential portions that appear darker and lighter.

### List of Reference Designations

1 . . . Sidewall
1a . . . Sidewall portion
2 . . . Set of lettering
2a . . . Text character
3 . . . Background design
4 . . . Rib
5 . . . Base surface
6, 6′ . . . Elevation
7 . . . Depression
8a, 8′a . . . Elevation
α, β₁, β₂ . . . Angle
a, a₂, a₃ . . . Spacing
b₁, b₂, b₃, b₄, b₅ . . . Width
h₁, h₂ . . . Height
t₁, t₂ . . . Depth

1.-14. (canceled)

15. A vehicle tire having two sidewalls, wherein, on at least one sidewall, at least one character is formed from a hatching composed of a multiplicity of ribs which run parallel to one another and which run with spacings to one another of at most 0.60 mm, wherein the character(s) is or are embedded into a sidewall portion having a background design which is composed of a smooth base surface and of elevations and/or depressions which run with spacings to one another and without intersecting and which form a hatching-like pattern,
wherein, in the background design, the base surface occupies two to ten times the area covered by the elevations and/or depressions, wherein at least 50% of the elevations and/or depressions run with spacings to one another that amount to two to five times the spacing of the ribs to one another.

16. The vehicle tire as claimed in claim 15, wherein, in the background design, the base surface occupies up to five times the area covered by the elevations and/or depressions.

17. The vehicle tire as claimed in claim 15, wherein, in the background design, all of the elevations and/or depressions run with spacings to one another that amount to two to five times the spacing of the ribs to one another.

18. The vehicle tire as claimed in claim 15, wherein, in the background design, all of the elevations and/or depressions run with equal or substantially equal spacings to one another.

19. The vehicle tire as claimed in claim 15, wherein, in the background design, the elevations and/or depressions extend in a radial direction.

20. The vehicle tire as claimed in claim 15, wherein, in the background design, the elevations and/or depressions extend at an angle of up to 450 with respect to a radial direction

21. The vehicle tire as claimed in claim 15, wherein, in the background design, the elevations and/or depressions run rectilinearly.

22. The vehicle tire as claimed in claim 15, wherein, in the background design, the elevations and/or depressions run in an altogether undulating or zigzag shape.

23. The vehicle tire as claimed in claim 15, wherein, in the background design, the elevations and/or depressions run in an altogether arcuate shape.

24. The vehicle tire as claimed in claim 15, wherein, in the background design, the elevations and/or depressions run partially in a zigzag or undulating shape and partially rectilinearly or substantially rectilinearly, wherein, in the case of mutually adjacent elevations and/or depressions, a progressive decrease of the angles in the portions of the zigzag profile or undulating shape gives rise to a transition to more rectilinearly running, or to rectilinearly running, elevations and/or depressions, wherein these are then followed again by elevations and/or depressions running in a zigzag or undulating shape with increasing angles in the portions of the zigzag profile or undulating shape.

25. The vehicle tire as claimed in claim 15, wherein the sidewall portion provided with the background design is followed by further sidewall portions which are free from characters, which have patterns consisting of elevations and/or depressions running in a zigzag or undulating shape, and in which a variation of the angles of portions of elevations and/or depressions running in a zigzag or undulating shape, and/or a variation of the spacing of elevations and/or depressions to one another, gives rise to a pattern consisting of pattern elements that appear darker and lighter.

26. The vehicle tire as claimed in claim 15, wherein the elevations are triangular in cross section, have a greatest height in relation to the base surface of 0.15 mm to 0.50 mm, and at their base have a width of 0.30 mm to 0.60 mm.

27. The vehicle tire as claimed in claim 15, wherein the depressions are V-shaped in cross section, have a greatest depth of 0.15 mm to 0.50 mm, and at the level of the base surface have a width of 0.30 mm to 0.60 mm.

28. The vehicle tire as claimed in claim 15, wherein each character that is embedded in the background design is a depression, with a depth of 0.20 mm to 1.00 mm, in the base surface, on the bottom of which depression the ribs are formed.

29. The vehicle tire as claimed in claim 15, wherein the ribs run rectilinearly or in an altogether arcuate shape and have a height that is smaller than the depth of the depression.

30. The vehicle tire as claimed in claim 29, wherein the ribs have a height that is smaller than the depth of the depression by 0.10 mm to 0.20 mm.

31. The vehicle tire as claimed in claim 15, wherein the ribs have at their base a width of 0.30 mm to 0.60 mm.

32. The vehicle tire as claimed in claim 15, wherein the ribs extend at an angle of 30° to 50° relative to the circumferential direction of the sidewall.

33. The vehicle tire as claimed in claim 15, wherein the at least one character is a text character, a numeral, or a pictorial element.
